(19) United States
(12) Patent Application Publication
(10) Pub. No.: US 2011/0291798 A1
(43) Pub. Date: Dec. 1, 2011

(54) Wireless Encrypted Control of Physical Access Systems

(75) Inventor: Norman Schibuk, Merrick, NY (US)

(73) Assignee: SURIDX, INC., Wellesley, MA (US)

(21) Appl. No.: 13/149,673

(22) Filed: May 31, 2011

Related U.S. Application Data
(60) Provisional application No. 61/349,278, filed on May 28, 2010.

(51) Int. Cl. G08B 29/00; G06K 5/00

(52) U.S. Cl. 340/5.61; 235/382; 340/5.6

(57) ABSTRACT

Physical access systems and methods securely grant physical access to restricted areas in high-volume applications. An electronic device, such as a smartphone, stores a digitally signed physical access rights file. An individual uses this rights file to gain access to a restricted area only after self-authenticating to the device. A physical access control system receives the rights file, validates it, and determines whether to permit passage through a physical barrier. The determination may be made by a physical barrier system, or by a remote access control headend. An access control gateway, which may be an access control headend, may either unlock the physical barrier system when the electronic device is near the physical barrier, or it may transmit an authorization code to the electronic device and the physical barrier system, whereby passage is only permitted if the barrier system subsequently receives the authorization code from the electronic device using near field communications.

### CROSS REFERENCE TO RELATED APPLICATION

This application claims the benefit of my U.S. Provisional application No. 61/349,278, filed May 28, 2010, which application is incorporated herein by reference in its entirety.

### TECHNICAL FIELD

The present invention relates to physical access systems, and more particularly to systems and methods of using portable wireless electronic devices having encryption capabilities to facilitate secure entry into areas protected by physical barriers.

### BACKGROUND ART

Restricted areas may be found at the premises of many commercial businesses and government agencies, such as banks, public transit stations, military installations and the like. Often, these restricted areas are protected from access by unauthorized visitors using physical access systems. A physical access system may include a physical barrier controlled by an electronic lock, for instance an electronic turnstile. A physical access control system (hereinafter, “ACS”) determines who is permitted to enter by collecting personal information from each individual. Individuals may, for example, enter a personal pin into a keypad integrated into the physical barrier, or swipe an identification card.

Some varieties of ACS use a technique known as “flash-and-go”, where an individual “flashes” an access device by tapping it to, or placing it near, a card reader integrated into the barrier. Data that are stored on the card are then transferred to the ACS. In some systems that use badges or proximity (“prox”) cards, data transfer is accomplished using a short-range radio frequency process described in ISO/IEC standard 14443. In other systems, vicinity cards having a longer ranger are used; these cards are described in ISO/IEC 15693. In other flash-and-go systems that use mobile phones, data transfer is made using short-range communications technologies such as near field communication (hereinafter, “NFC”), which is a backward-compatible extension of the prox card interface, or using medium-range communications technologies such as Bluetooth.

In some flash-and-go systems, the data stored on the card include a hard-wired physical card number. This card number is transmitted to a headend that determines whether the holder of the card should be permitted access into the restricted area. If so, an electrical signal is transmitted from the headend to the barrier, causing the barrier to open. Such systems are insecure, in that if an access card is lost or stolen, it may be used by someone other than the person to whom it was originally issued, thereby allowing an unauthorized access into the restricted area. Thus, operators of this type of ACS may further require the user to enter a password or biometric before access is granted. However, this approach has the disadvantage that it slows access to the restricted area for authorized individuals, and is therefore not ideal for high-volume settings.

In other flash-and-go systems that require payment for access, especially in high-volume settings such as subway systems, the access card itself may store data such as a cash balance. Flashing the access card in this instance causes the ACS to determine whether the balance is sufficient to permit entry. If so, the system debits the cash balance by the appropriate amount, stores the new balance on the card, and opens the barrier. This type of system permits local account debiting and batch reconciliation, and avoids the need for a physical access headend remote from the physical barrier. However, the system suffers from the possibility that an unscrupulous individual will use a contactless card writer to improperly alter the data stored on the card (for example, by increasing the stored cash balance.) In typical deployments, card writing is beyond the capabilities or desires of the vast majority of intended users of such payment systems, and expected losses from such activities are tolerably small. However, these systems are inappropriate where card writing is not beyond the capability of a determined attacker and expected losses are large. Financial institutions in particular often operate buildings having restricted areas that contain valuable financial information, and cannot rely on the integrity of authentication data stored on access cards. Yet these same institutions may employ thousands of people, who must pass through the physical barriers at least twice each day.

### SUMMARY OF ILLUSTRATED EMBODIMENTS

The foregoing problems may be solved through the use of an electronic device that requires self-authentication, such as a smartphone, rather than a prox card to gain access to restricted areas. This requirement alleviates the security issues that arise when prox cards are lost or stolen, as a stolen phone is login-protected, and may be remotely deactivated. The illustrated embodiments also require that the electronic device communicate a rights file to the ACS. The rights file may be generated under secure conditions and digitally signed by a digital certificate that is trusted by the system. This requirement solves the problem of otherwise trusted employees who forge credentials above their assigned access levels. In some embodiments, the electronic device communicates the rights file to the physical barrier system directly, via NFC, while in other embodiments the rights file is sent to a ACS headend from a medium-range or long-range distance using a wireless communications network. In the latter embodiments, the headend generates a temporary authorization code (for example, a random number of sufficient length) and transmits it both to a physical barrier system directly, and to the electronic device. The individual is only permitted access when the physical barrier system receives the authorization code from the device using near field communication. In both cases the electronic device must transmit data to the physical barrier in close physical proximity before the barrier is opened.

Thus, in a first illustrated embodiment there is provided an access control system for granting physical access to a restricted area to an individual who controls an electronic device. Physical access is controlled by a physical barrier system having a physical barrier of which movement is restricted by a lock. The system includes an access control gateway, a proximity data receiver, and a lock controller.

The access control gateway has a computer processor configured to wirelessly receive from the electronic device digitally signed data that pertain to physical access rights, the electronic device having been configured to transmit the digitally signed data only after the individual has self-authenticated to the electronic device. The computer processor is also configured to determine, on the basis of the received data, whether the individual is permitted to access the restricted area. The proximity data receiver receives proximity data from the electronic device indicating close physical proximity of the electronic device to the lock. The lock controller is in communication with the access control gateway, and is configured to change the lock from a locked state to an unlocked state following occurrence of both of two conditions. These conditions are: (i) the access control gateway has determined that the individual is permitted to access the restricted area and (ii) the proximity data have been received by the proximity data receiver so as to indicate that the electronic device is within close physical proximity to the lock. The proximity data receiver is coupled to one of the access control gateway and the lock controller.

There are various disclosed embodiments that include improvements on the basic system. For example, the electronic device may be a smartphone or a tablet computer and the access control gateway is an access control headend. The access control gateway may be an access control headend configured to receive the digitally signed data from the electronic device using at least one of a Bluetooth receiver, a wireless Ethernet receiver, and a cellular telephone interface. The access control gateway may be an access control headend that includes a digital storage medium storing a database having a collection of records as to authorization of individuals to access the restricted area. If so, the access control headend may be configured to alter the permission of the individual to access the restricted area by modifying at least one of the records in the database. In another embodiment, the electronic device has been configured to transmit the digitally signed data only after the individual has self-authenticated to the electronic device by presenting at least one of a fingerprint of the individual, a handprint of the individual, an iris scan of the individual, a retina scan of the individual, a password, an authorization code, or a personal identification number. In yet another related embodiment, the access control gateway is incorporated into the barrier system and receives the digitally signed data from the electronic device when the electronic device is in close proximity to the barrier, so that the digitally signed data additionally serve as the proximity data and the proximity data receiver is configured to receive the digitally signed data.

In one related embodiment, the access control gateway is an access control headend and further includes a transmitter configured to transmit a signal to the lock controller following occurrence of the conditions (i) and (ii), the signal commanding the lock controller to change the state of the lock. Optionally, the proximity receiver is located in the headend and the proximity data may include at least one of barcode data and RFID data that uniquely identify the lock.

In another related embodiment, the computer processor is further configured (i) to generate an authorization code when the received digitally signed data indicate that the individual is authorized to have access to the restricted area, (ii) to wirelessly transmit the authorization code to the electronic device, and (iii) to transmit the authorization code to the lock controller. In this embodiment, the lock controller is configured to change the state of the lock only after receiving the authorization code from the electronic device. The authorization code may expire at a given time, in which case the computer processor is configured to grant physical access only until the given time. The authorization code may be, for example, a randomly generated number. The computer processor may be configured to transmit the authorization code after encrypting it. In another related embodiment, the access control gateway is an access control headend, and the proximity data receiver is proximate to the physical barrier system, and the proximity data comprise the authorization code.

In yet another related embodiment, the access control headend is configured to query a certificate authority accessible over a network to determine whether a certificate used to digitally sign the digitally signed data has been revoked and if a response to the query from the certificate authority indicates that the certificate has been revoked, then determine that the individual is not permitted to access the restricted area.

There is also provided a method of granting physical access to a restricted area to an individual who controls an electronic device, physical access being controlled by a physical barrier system having a physical barrier of which movement is restricted by a lock. The method comprises wirelessly receiving, at an access control headend, from the electronic device, digitally signed data that pertain to physical access rights, the electronic device having been configured to transmit the digitally signed data only after the individual has self-authenticated to the electronic device. The method further comprises determining, in a first computing process, on the basis of the received data, whether the individual is permitted to access the restricted area. Next, the method includes receiving proximity data from the electronic device indicating close physical proximity of the electronic device to the lock. Finally, the method requires, after (i) determining the individual to be so permitted and (ii) receiving the proximity data, causing the lock to change from the locked state to the unlocked state. The electronic device may be a smartphone or a tablet computer. Wirelessly receiving may include receiving using at least one of Bluetooth, wireless Ethernet, and a cellular telephone network.

The method may further include storing, in digital storage medium, a database having a collection of records as to the authorization of individuals to access the restricted area. If so, the method may also include altering the permission of the individual to access the restricted area by modifying at least one of the records in the database.

The electronic device may have been configured to transmit the digitally signed data only after the individual has self-authenticated to the electronic device by presenting at least one of a fingerprint of the individual, a handprint of the individual, an iris scan of the individual, a retina scan of the individual, a password, an authorization code, or a personal identification number. In another related embodiment, the access control gateway is incorporated into the barrier system and receives the digitally signed data from the electronic device when the electronic device is in close proximity to the barrier, so that the digitally signed data additionally serve as the proximity data and the proximity data receiver is configured to receive the digitally signed data.

The method may further include, after (i) determining the individual to be so permitted and (ii) receiving the proximity data, transmitting a signal to the lock controller, the signal commanding the lock controller to change the state of the lock. If so, the proximity data may include at least one of barcode data and RFID data that uniquely identify the lock.

The method may further comprise generating an authorization code when the received digitally signed data indicate that the individual is authorized to have access to the restricted area; wirelessly transmitting the authorization code to the electronic device; and transmitting the authorization code to the lock controller. If so, the lock controller changes the state of the lock only after receiving the authorization code from the electronic device. In this method, the authorization code may expire at a given time, in which case the method includes granting physical access only until the given time. The authorization code may be a randomly generated number. Also, wirelessly transmitting may include transmitting an encrypted message containing the authorization code. Alternatively, or in addition, the access control gateway is an access control headend, and the proximity data receiver is proximate to the physical barrier system, and the proximity data comprise the authorization code.

The method may also further comprise querying a certificate authority accessible over a network to determine whether a certificate used to digitally sign the digitally signed data has been revoked; receiving a response to the query from the certificate authority; and if the response indicates that the certificate has been revoked, determining that the individual is not permitted to access the restricted area.

The above methods may be implemented using a computer program product executing in the access control headend, the physical barrier system, or both.

### BRIEF DESCRIPTION OF THE DRAWINGS

The foregoing features of the illustrated embodiments of the invention will be more readily understood by reference to the following detailed description, taken with reference to the accompanying drawings, in which:

FIG. 1 shows a physical access system embodiment of the present invention;

FIG. 2 is a flowchart showing a process for initializing a physical access system and an electronic device in accordance with an embodiment of the present invention;

FIG. 3 is a flowchart showing a process for granting physical access to a restricted area behind a physical barrier system to an individual who controls an electronic device in accordance with an embodiment of the present invention;

FIG. 4 is a flowchart showing an alternate process for granting physical access that may be used in conjunction with legacy physical barrier systems in accordance with an embodiment of the present invention;

FIG. 4A is a flowchart showing another alternate process for granting physical access n accordance with an embodiment of the present invention; and

FIG. 5 is a flowchart showing a process for updating or revoking an individual's access rights n accordance with an embodiment of the present invention.

### DETAILED DESCRIPTION OF SPECIFIC EMBODIMENTS

As used in this description and the appended claims, “close physical proximity” is defined as the effective range of wireless near field communication, as that phrase is defined by the Ecma International Standards Organization, in standards upon which the Ecma relies, and in similar standards. Of particular relevance are the following standards: ECMA-340, ECMA-352, ECMA-385, ECMA-386, ISO/IEC 14443 (parts 1 and 2), and ISO/IEC 15693 (parts 1 and 2).

A “physical barrier system” (or “barrier system”) is an electrical or mechanical system that prevents passage of an individual into a location. Barrier systems include a physical barrier and a lock. The physical barrier may be a door or a gate, among other things. The lock may be a cylinder lock for use with a key, or an embedded bolt driven by a solenoid, among other things. The barrier's movement is restricted by the lock, which has a locked state, in which the barrier bars physical access, and an unlocked state, in which the barrier does not bar physical access.

A “physical access system” is an electrical or mechanical system that secures physical access to a location. A physical access system includes a physical barrier system as defined above, but may include a remote locking and unlocking mechanism such as an access control headend that selectively unlocks the lock based on requests from properly authenticated and authorized individuals.

A “rights file” is an electronic document that contains physical access rights information for use by a physical access system. Each rights file may be digitally signed, and is associated with a digital certificate that contains encryption keys used to sign or verify the signature of the rights file, using methods known in the art for performing digital signatures. Such a certificate may be generated in a secure location and securely distributed (for example, by courier on a CD) to each premises of the entity using the rights file.

An “electronic device” is a portable computing device having wireless communication capability and a facility for user authentication to the device, such as a smartphone, or a tablet computing device, each optionally having a fingerprint reader or other arrangement for authentication, such as iris scanner, retina scanner, or programmed to receive keyed input of a password, an authorization code, or a personal identification number.

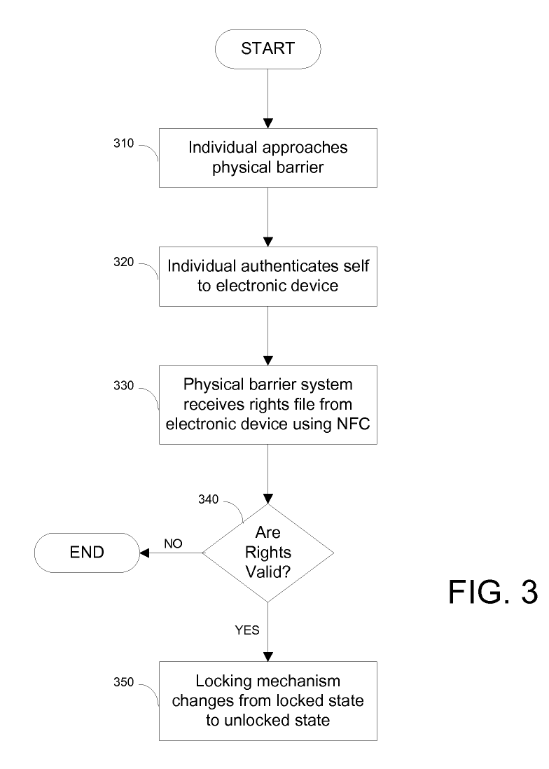

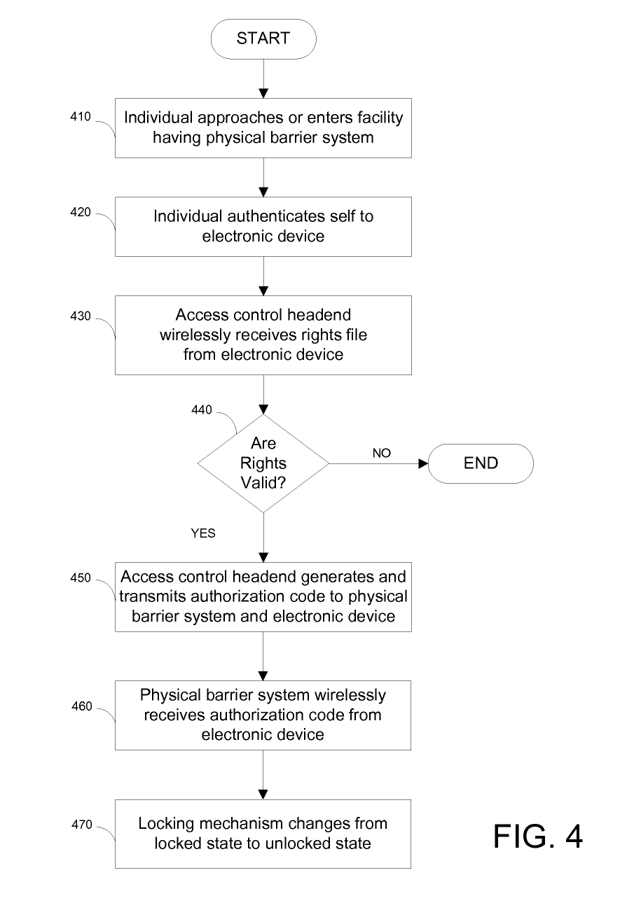

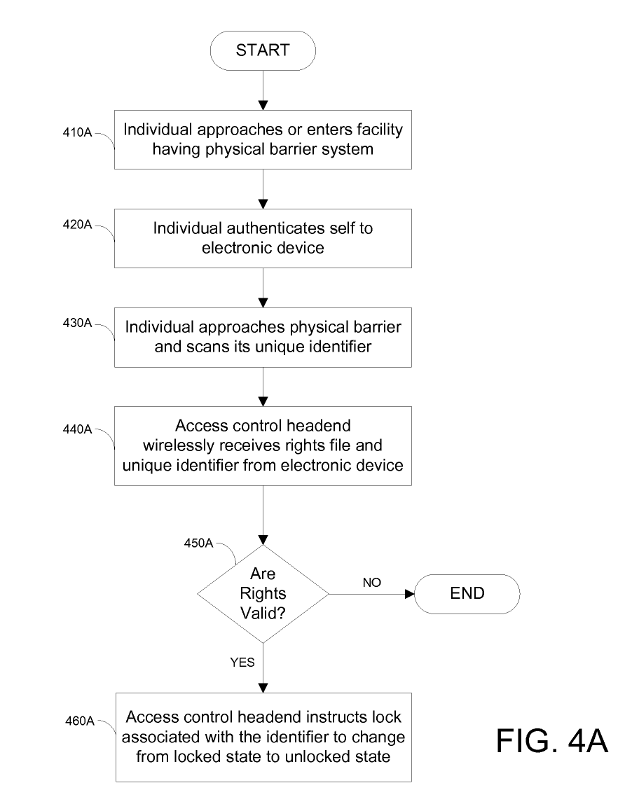

“Proximity data” are data, transmitted by the electronic device to a physical access system, that indicate that the electronic device is in close physical proximity to a barrier system. As described more fully below, “proximity data” may include but is not limited to any data that are sent using near field communications (but not medium- or long-range communications) from the electronic device to the barrier system. These data may include, for example, a rights file (as in the case of the embodiment described in connection with FIG. 3) or a one-time authorization code (as in the case of the embodiment described in connection with FIG. 4). Proximity data also may include specific data, sent by medium- or long-range communications, that uniquely identify a particular barrier, so long as these data were obtained by the electronic device while in close physical proximity to the identified barrier. These data may include, for example, barcode data or RFID data (as in the case, for example, of the embodiment described in connection with FIG. 4A), located on or near the physical barrier itself, that are obtained by the electronic device.

A “proximity data receiver,” is a data receiver configured to receive proximity data.

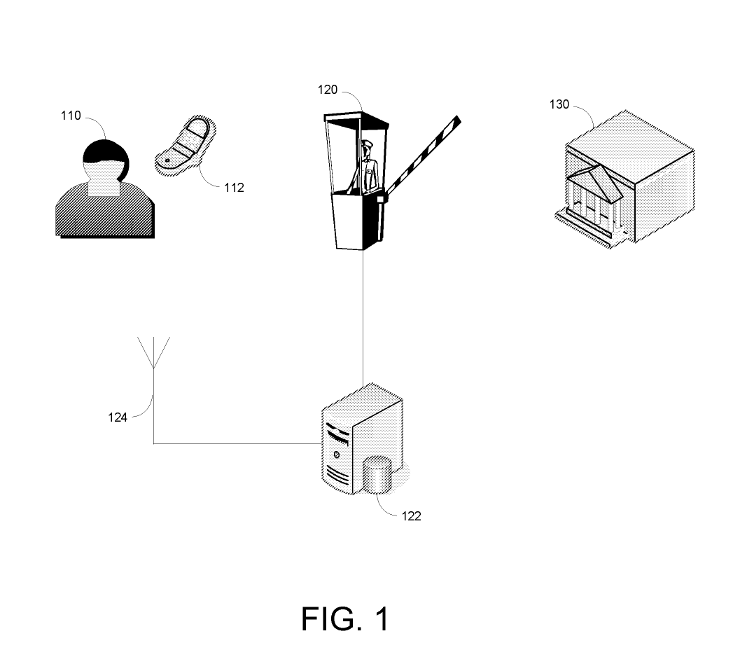

One embodiment of a physical access system in accordance with the present invention is shown in FIG. 1. In this embodiment, an individual 110 having an electronic device 112 seeks access to a restricted area at a premises 130, such as a bank. Access is protected using a physical access system that includes a physical barrier system 120. For illustrative purposes, the electronic device 112 is shown as a smartphone and the barrier system 120 is depicted as a guard house having a barrier gate. The physical barrier is coupled to a lock controller, which in turn is ultimately controlled by the ACS headend 122.

In accordance with the embodiment of FIG. 1, an ACS gateway, here implemented as ACS headend 122, includes a rights management system described in more detail below. The electronic device 112 must be registered with the ACS headend 122 using the rights management system, prior to the individual 110 obtaining access to the restricted area. The access control headend 122 is itself connected to a wireless communications network, depicted here by an antenna 124. The communications network is designed to receive transmissions from the electronic device 112, shown here as a smartphone. The communications network may be a medium-range network such as a Bluetooth network or wireless Ethernet network, or a long-range network such as a cellular telephone network.

When the individual 110 wishes to pass the physical barrier system 120, the device 112 transmits a digital rights file to access control headend 122 through medium- or long-range communications. When the individual enters close physical proximity to the barrier, the headend 122 causes the lock controller to unlock the barrier. In one embodiment, the headend 122 directly commands the lock controller to change the state of the lock, for example by sending a signal through a wire connecting the headend 122 to the barrier system 120. In another embodiment, the device 112 and the barrier system 120 use near field communications to exchange authorization data that permit the individual to pass the barrier. At some later time, the individual's access permissions may be updated, or even revoked, by the physical access system. These processes are explained with reference to the remaining figures.

It should be understood that other types of physical barriers, both manned and unmanned, may be used in other embodiments. For example, a fully automated electronic turnstile may be used instead of a guarded gate. Or, the restricted area may be a room in a building, and the physical barrier is a door to the room that has an electronically controlled lock controller. The scope of the invention is thus not limited to the elements depicted in FIG. 1, and those having skill in the art of physical access systems may envision other situations to which the description herein applies.

Some organizations have difficulties providing their employees with uniform physical access to various locations under their control. For example, a large corporation may have acquired many offices and buildings in different locations through acquisitions or growth. Each building or office campus may have a separate ACS that relies on a local ACS headend. The computer systems that control the headends may not be interoperable with the systems at other locations, making common access mechanisms difficult without custom software development at a cost in time and money. However, in various embodiments of this invention, access control data is stored on a mobile electronic device and may be used according to a common scheme either with a central access control headend or with a local barrier system, substantially mitigating these costs.

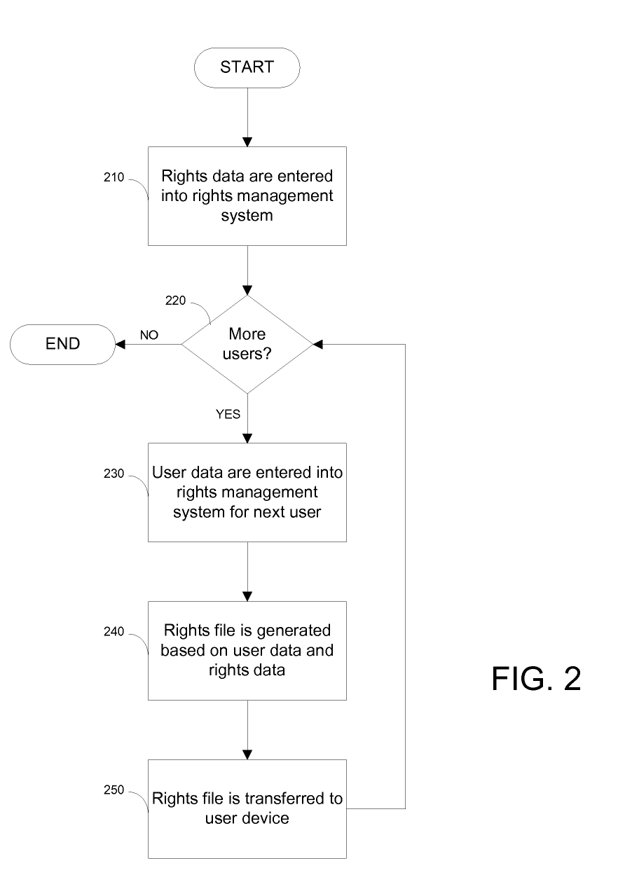

FIG. 2 is a block diagram of a process by which a person may register an electronic device 112 (such as their smartphone) with a physical access system in accordance with an embodiment of the invention, to prepare for obtaining physical access to a secured area. In accordance with the embodiment of FIG. 2, rights data are entered into a rights management system in process 210. This rights management system is typically embodied as a database stored in a digital storage medium, as is known in the art, and may be located at a headquarters building or any other premises of the organization. Rights data may include access rights tied to an individual, job title, or administrative rank that identify an individual's authorization to access each secure area. For example, an organization may decide that only an employee with job title including “accountant” may have access to rooms containing financial data of the organization, or employees named John Smith may have access to only public areas. Persons having skill in the art may develop other types of rights data that fall within the scope of the invention. Process 210 typically occurs during the initialization of the physical access system itself, and from time to time when the business requirements of the organization change.

In the remainder of the figure, individuals are given access rights through a multi-step process. In process 220, an organization determines to grant physical access to one or more users (for example, employees or on-site contractors). In process 230, user authentication data pertaining to an individual are entered into the rights management system. These data include routine identification information, such as a name, address, telephone number, employee ID, administrative rank (such as employee, manager, or director), job title, or other similar data which may be later used to identify the person.

In process 240, user authentication data are compared with the authorization rights data previously entered, and a rights file is generated. This may be done, for example, by comparing the individual's job title entered in process 230 with the authorization data relating to that job title entered in process 210. Other data may be compared directly or according to various business rules to determine the individual's authorization, as will be understood by those of ordinary skill in the art. In process 250, the generated rights file is securely transferred to the user's electronic device 112, typically in such a manner as to prevent unwanted dissemination of any encryption data associated with the rights file. For example, the user data may be entered in a secure physical location while the electronic device is physically present, and the rights file may be transferred by way of shielded, wired connection or near field communications between the rights management system and the electronic device. In this way, or according to similar security measures known in the art, the security of the rights file data is preserved. The registration cycle then repeats for the next user until all users have been entered into the system. As noted above, additional users may be entered at a later time by proceeding from process 220.

FIGS. 3, 4, and 4A are flowcharts showing various methods that may be used to grant physical access to a restricted area behind a barrier system in accordance with embodiments of the invention. Each method assumes as a pre-condition that the barrier system and individual's electronic device have been initialized in accordance with the processes shown in FIG. 2. FIG. 3 illustrates a method for use with a physical access system in which the barrier system receives a rights file from the electronic device. The method of FIG. 3 may be used when no centralized ACS headend is available or desired (although one may be used, as discussed below). FIG. 4 shows a method for use with a physical access system in which a ACS headend receives the rights file and distributes authorization codes to both the barrier system and the electronic device. The method of FIG. 4 may be used in physical access systems whose barrier systems are unable to process rights files themselves, but are equipped with NFC. This may be the case in certain legacy systems, in which this embodiment advantageously may be deployed without requiring a retrofit. FIG. 4A depicts a method for use with a physical access system in which an access control headend receives the rights file and unlocks the barrier directly. The method of FIG. 4A may be used in physical access systems whose barrier systems are not equipped even with NFC.

Regarding FIG. 3, in process 310 an individual having an electronic device 112 (such as a smartphone) approaches a physical barrier. The device 112 already has been initialized, and therefore contains a rights file as described above. In process 320, the individual self-authenticates to the electronic device. Such processes are known in the art, and may include the individual presenting a fingerprint, handprint, iris scan, retina scan, password, authorization code, or personal identification number (PIN) to the device. In process 330, the electronic device uses near field communications (NFC) to transmit the rights file to a receiver in the physical barrier system, and the barrier system receives this file using a data receiver. In this embodiment, the rights file, besides conveying the substantive information therein, additionally serves as proximity data to indicate close physical proximity of the electronic device 112 to the lock, because the file is received by the physical barrier system using NFC. Furthermore, then, the data receiver also serves as a proximity data receiver.

In process 340, the ACS gateway makes a determination whether the rights file is valid, and whether the rights contained within permit the individual to access the restricted area behind the physical barrier. In some embodiments, the barrier system itself may make this determination, when the barrier system is equipped with components establishing an ACS gateway that functions in a manner analogous to the headend 122 of FIG. 1. In other embodiments of the ACS, the barrier system transmits, typically by wired communications, the rights file to an ACS gateway implemented in the manner of central ACS headend 122 of FIG. 1, which makes the determination whether the rights file is valid. The determination in process 340 may be made, for example, by a commercial, off-the-shelf (COTS) computer system, custom-built and proprietary hardware (including embedded systems), or any other system known in the art that permits the required validation.

Validation itself generally includes two steps: determining that the rights file itself is valid, and determining whether the rights are sufficient to permit access to the restricted area. The first step may be accomplished according to methods known in the art, but in illustrative embodiments the rights file is digitally signed, and validation is performed by validating the digital signature. Such validation may include using a digital certificate associated with the rights file, a digital certificate associated with the organization, or both. These digital certificates may be generated in the facility housing the barrier system, or in another facility and transferred securely to the system that performs the determination. Verifying the digital signature may be accomplished by querying a certificate authority, accessible over a data network to determine whether the certificate used to digitally sign the rights file has been revoked. Alternatively, the certificate authority may regularly publish certificate revocation lists to the ACS that avoid the need for a separate query. If the certificate authority indicates that the certificate has been revoked using whatever method, then the ACS may determine that the individual is not permitted to access the restricted area.

The second step, comparing the rights file presented against the requested access, also may be performed using any number of methods known in the art. For example, the sufficiency of the rights may be tested by searching for the presence or absence of a particular datum in the rights file. Thus, the rights file may be encoded using XML, and the presence a particular XML key may be required to permit access beyond the physical barrier.

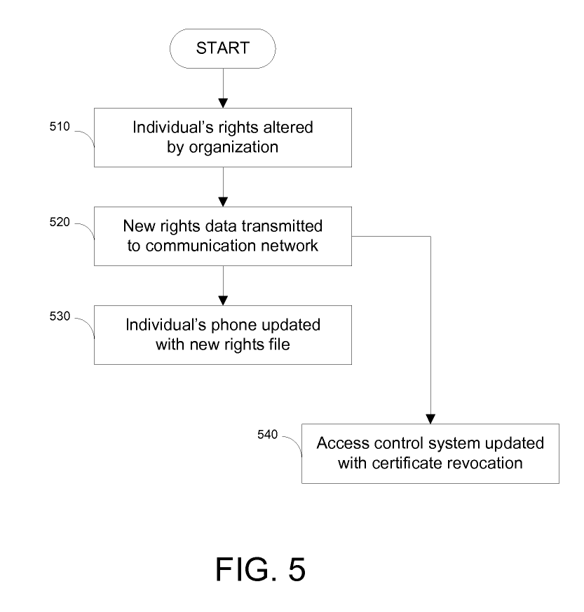

If the rights file is determined to be invalid or insufficient, then the method of FIG. 3 ends as indicated, and the individual is not granted physical access to the restricted area. However, if the rights file is determined to be valid and sufficient, and since the individual's electronic device has been determined to be in close physical proximity to the lock, then in process 350 a lock controller changes the lock from a locked state to an unlocked state, permitting access to the space beyond. If the determination is performed in the barrier system itself, then this process 350 advantageously does not require the barrier system to communicate with a remote ACS headend at all. However, the barrier system must perform all of the validation, which increases its cost to manufacture and maintain. If the determination is made remotely, then the lock controller must be configured to receive a command from the remote ACS headend to remove its physical barrier prior to executing process 350. In such cases, the ACS headend may optionally store the rights file locally in a database of validated rights files. This database may be used in conjunction with a database of revoked rights files, as described below in connection with FIG. 5, to instantly revoke an individual's permission to be in a restricted area.

The method shown in FIG. 3 may not be suitable for use in some environments having legacy physical access control systems. For instance, a facility may possess a large number of installed barrier systems that are capable only of comparing a received authorization code against a list of authorization codes provided by a central access control headend. Such systems are typically used with proximity cards or vicinity cards having fixed hardware identification codes embedded inside them. For such legacy installations, the method may be adapted as shown in FIG. 4. The method shown in FIG. 4 may also be used in new installations, as it provides several advantages that relate to high-volume, securely granted physical access.

The method begins in process 410, where an individual approaches or enters a facility having an installed physical barrier system. In process 420, the individual self-authenticates to the electronic device in a manner entirely analogous to process 320. However, in process 430, the ACS gateway, here implemented as ACS headend (rather than in the barrier system as in the case of FIG. 3) wirelessly receives the rights file from the electronic device. On the other hand, the individual need not be in close physical proximity to the barrier system for process 430 to successfully complete, and so an alternative method (described in the next paragraph) of obtaining proximity data is required. Typically, the ACS headend will receive this information via a medium-range network such as wireless Ethernet (to a local access point), or a long-range wireless network such as a cellular telephone network. Thus, after upgrading an existing ACS headend to enable it to receive this rights file, individual barrier systems may be left intact.

Next, in process 440, the ACS gateway determines whether the rights file is valid, and whether to permit the individual to access the restricted area, in the manner described above in connection with process 340. As before, if the individual should not be granted access, the method of FIG. 4 terminates. If the individual should be granted physical access to the restricted area, the method of FIG. 4 diverges from that of FIG. 3 because the individual is not necessarily in close proximity to the physical barrier. Thus, in process 450, the ACS headend generates an authorization code that will later permit the individual to enter the restricted area, and transmits it to a barrier system in the individual's relative proximity, and to the individual's electronic device. At some later time, the individual approaches the barrier system. At this time, the barrier system wirelessly receives the authorization code from the electronic device using near field communication, in process 460. If the received authorization code matches the list of current authorization codes, the lock controller unlocks in process 470, allowing passage. Thus, in this embodiment, the authorization code (and not the rights file) acts as proximity data that indicate close physical proximity of the electronic device to the lock.

The authorization code described above is similar in function to a hard-wired prox card identifier, but advantageously may be changed each time the individual wishes to enter the restricted area. In one embodiment, the authorization code is a randomly generated number of sufficient length to deter replay attacks. In another embodiment, the authorization code expires at a given time (for example, at the close of the business day), or after a fixed period (perhaps two minutes, the time it might take to walk from a lobby to the physical barrier). Thus, the individual may use the authorization code in the barrier system until the given time, after which the ACS automatically revokes the code. Subsequent re-entry then requires the individual to again self-authenticate to the electronic device. The same authorization code may be used in any collection of barrier systems within a facility. Typically, such a collection is defined by the rights file, by the ACS headend, or a combination of both.

To provided added security, communication may be encrypted between the electronic device and both the barrier system and the ACS headend, using methods well known in the art. Such encryption preferably is based on a public/private encryption system where the encryption keys are stored in digitally signed certificates that have been physically secured, and are not accessible from a public network or a certificate authority.

The methods just described advantageously provide a reduced transaction latency time for physical access transactions. When granting physical access to an individual, high latency times result in the individual being dissatisfied with the access process. If a person must wait in front of a gate, such as a public transportation turnstile, toll booth, or other access point for a lengthy period every day, they may become frustrated or upset. The method of FIG. 4 solves this problem by separating the processes of authorization and action. Now, instead of (for example) waiting at a turnstile for authorization to occur, a person may authorize the entry transaction when entering a subway station. The process to authorize then completes before the person has approached the turnstile. When the user does enter close physical proximity to the turnstile, the actual entry transaction may complete in a short period. This result is obtained even in legacy systems with very simple locking mechanisms.

The method of FIG. 4A is similar to the method of FIG. 4, but may be used with systems that are even simpler than those described above. In particular, this method may be used with fixed-location, passive technology such as 2D and 3D barcodes and passive RFID tags, among others. These passive technologies are generally much less expensive to create and maintain than devices that require the active receipt and transmission of data, and may therefore be advantageously deployed in environments having a great number of separate secure areas. Use of this method thereby reduces the cost of new installations and allows the concepts disclosed herein to be used with inexpensive physical barrier systems.

This method begins with processes 410A and 420A that are analogous to those describe in connection with FIG. 4. Thus, the individual approaches the facility and self-authenticates to the electronic device. However, in process 430A, the individual approaches a physical barrier and scans its unique identifier. This identifier may be present as a 2D or 3D barcode located in close physical proximity to the physical barrier, and indeed may be printed on the barrier or barrier system itself. For example, a barcode may be located on a door tag on or next to a locked door. For even more security, the identifier may be hidden within an RFID tag located near a door or barrier, and may be indicated by a tap spot. Techniques for scanning barcodes and RFID tags are known in the art, and other types of scannable unique identifiers may be used in conjunction with embodiments of the invention.

The method continues in process 440A, where the ACS gateway, implemented as ACS headend, wirelessly receives from the electronic device not just the rights file, but also the scanned unique identifier. Typically, this is done as in process 430. In this embodiment, however, the scanned unique identifier acts as the proximity data that indicate close physical proximity of the electronic device to the lock. Further, in this embodiment, the ACS headend receives the proximity data directly; these data do not pass through the physical barrier system at all. Thus, in some embodiments the lock controller in the physical barrier system receives the proximity data, while in others the ACS headend receives these data.

In process 450A, the ACS headend determines whether the rights are valid, as in process 440. However, this method differs from that of FIG. 4, because receipt of the unique identifier at the same time as the rights file may be treated by the ACS headend as an indication that the electronic device is already in close proximity to a physical barrier system (and in particular, to the physical barrier system identified by the unique identifier). Thus, in process 460A, the ACS headend may immediately instruct or command the lock controller associated with the unique identifier to change from its locked state to its unlocked state. This command may be sent, for example, by a physical wire to a simple solenoid that draws back a bolt. Such simple bolt-and-solenoid systems are well known in the art to be relatively inexpensive as compared to systems that require processing of authentication codes. While NFC may have been used in the form of scanning an RFID tag, this function was advantageously performed by the electronic device, not by an actively-powered processor and receiver in the physical access system itself. In fact, NFC may be entirely omitted in the embodiment where a barcode is optically scanned, and many smartphones already come with built-in cameras that can scan such barcodes.

To provide further added security to the methods of FIGS. 4 and 4A, video surveillance may be used. The above methods, while an improvement over the prior art in legacy systems that have very simple locking mechanisms, cannot account for a door being locked but nevertheless ajar. Thus, an authorized individual may gain access to a secure area and unlock a door, but then hold open the door for an unauthorized individual to enter. To combat this “tailgating” problem, video surveillance may be employed. In accordance with a video surveillance embodiment, a video camera already in place may be used to determine the condition of a door or other physical barrier (e.g., open/closed, as opposed to locked/unlocked) without installing additional sensors. Video analytic techniques known in the art may be used to determine this condition, and the results are fed into the ACS headend to provide additional security information, including, for each individual access point and each individual access event: time of barrier open and close, person who was granted access, video of additional (unauthorized) persons who passed through the barrier, and so on. This information can be further analyzed, for example, to immediately revoke the access of the person who passed the unauthorized tailgater through the access point. As an alternate embodiment, the video image of the person who self-authenticated to the electronic device may be analyzed to determine whether this person is actually the person authorized to have access. Such analysis advantageously prevents physical access being given to an unauthorized person who has the electronic device and password of an authorized person.

FIG. 5 is a flowchart showing a process for updating or revoking an individual's access rights. In process 510 an individual's access rights are altered by an organization, such as the organization that originally provided the rights file in accordance with the processes of FIG. 2. This may be done by either altering the rights file itself, altering the authorization records in the database, or by revoking the digital certificate used to sign the rights file. The rights file may be altered for any number of reasons, and may be done to increase an individual's access to certain physical locations, to decrease the individual's access, to renew the individual's access (for example, if the phone is lost or stolen), and so on. Or, the digital certificate used to sign the rights file may be revoked to entirely prohibit further use of the rights file at all (thus implicitly revoking all of the individual's access rights). Certificate revocation may be performed, for example, if the individual's employment with the organization is involuntarily terminated. Certificate revocation may be executed using techniques well known in the art.

In process 520, the new rights data are transmitted to a communication network that is received by the individual's electronic device 112. This network may be, for example, a cellular telephone network, a wireless Ethernet network, a metropolitan area network, the Internet, or any other known communication network or combination of networks. If the new rights data include an altered rights file, then in process 530 the individual's electronic device 112 receives the new rights file, and updates its local memory. Subsequently, the device transmits the new rights file each time it communicates with a barrier system using near field communication in accordance with FIG. 3, or communicates with a ACS headend in accordance with FIG. 4 or FIG. 4A. On the other hand, if the new rights data include a certificate revocation, the ACS receives the revocation from the communication network in process 540. Upon subsequent receipt of the rights file from the individual's device, the ACS will be prevented from verifying the signature on the rights file due to the revocation of the certificate, and will therefore deny entry to the individual.

The embodiments of the invention described above are intended to be merely exemplary; numerous variations and modifications will be apparent to those skilled in the art. All such variations and modifications are intended to be within the scope of the present invention as defined in any appended claims.

It should be noted that the logic flow diagrams are used herein to demonstrate various aspects of certain embodiments, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic and programmable logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program or programmable logic may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

What is claimed is:

1. An access control system for granting physical access to a restricted area to an individual who controls an electronic device, physical access being controlled by a physical barrier system having a physical barrier of which movement is restricted by a lock, the system comprising:
an access control gateway, having a computer processor, configured (a) to wirelessly receive from the electronic device digitally signed data that pertain to physical access rights, the electronic device having been configured to transmit the digitally signed data only after the individual has self-authenticated to the electronic device and (b) to determine, on the basis of the received data, whether the individual is permitted to access the restricted area;
a proximity data receiver that receives proximity data from the electronic device indicating close physical proximity of the electronic device to the lock; and
a lock controller in communication with the access control gateway, the lock controller being configured to change the lock from a locked state to an unlocked state following occurrence of conditions wherein (i) the access control gateway has determined that the individual is permitted to access the restricted area and (ii) the proximity data have been received by the proximity data receiver so as to indicate that the electronic device is within close physical proximity to the lock;
wherein the proximity data receiver is coupled to one of the access control gateway and the lock controller.

2. A system according to claim 1, wherein the electronic device comprises a smartphone or a tablet computer and the access control gateway is an access control headend.

3. The system of claim 1, wherein the access control gateway is an access control headend and is configured to receive the digitally signed data from the electronic device using at least one of a Bluetooth receiver, a wireless Ethernet receiver, and a cellular telephone interface.

4. A system according to claim 1, wherein the access control gateway is an access control headend and includes a digital storage medium storing a database having a collection of records as to authorization of individuals to access the restricted area.

5. The system of claim 4, wherein the access control headend is further configured to alter the permission of the individual to access the restricted area by modifying at least one of the records in the database.

6. A system according to claim 1, wherein the electronic device has been configured to transmit the digitally signed data only after the individual has self-authenticated to the electronic device by presenting at least one of a fingerprint of the individual, a handprint of the individual, an iris scan of the individual, a retina scan of the individual, a password, an authorization code, or a personal identification number.

7. A system according to claim 1, wherein the access control gateway is incorporated into the barrier system and receives the digitally signed data from the electronic device when the electronic device is in close proximity to the barrier, so that the digitally signed data additionally serve as the proximity data and the proximity data receiver is configured to receive the digitally signed data.

8. A system according to claim 1, wherein the access control gateway is an access control headend and further includes a transmitter configured to transmit a signal to the lock controller following occurrence of the conditions (i) and (ii), the signal commanding the lock controller to change the state of the lock.

9. A system according to claim 8, wherein the proximity receiver is located in the headend and the proximity data include at least one of barcode data and RFID data that uniquely identify the lock.

10. A system according to claim 1, wherein the computer processor is further configured (i) to generate an authorization code when the received digitally signed data indicate that the individual is authorized to have access to the restricted area, (ii) to wirelessly transmit the authorization code to the electronic device, and (iii) to transmit the authorization code to the lock controller, and wherein the lock controller is further configured to change the state of the lock only after receiving the authorization code from the electronic device.

11. A system according to claim 10, wherein the authorization code expires at a given time, and the computer processor is further configured to grant physical access only until the given time.

12. A system according to claim 10, wherein the authorization code is a randomly generated number.

13. A system according to claim 10, wherein the computer processor is further configured to transmit the authorization code after encrypting the authorization code.

14. A system according to claim 10, wherein the access control gateway is an access control headend, and the proximity data receiver is proximate to the physical barrier system, and the proximity data comprise the authorization code.

15. A system according to claim 1, wherein the access control headend is further configured to query a certificate authority accessible over a network to determine whether a certificate used to digitally sign the digitally signed data has been revoked and if a response to the query from the certificate authority indicates that the certificate has been revoked, then determine that the individual is not permitted to access the restricted area.

16. A method of granting physical access to a restricted area to an individual who controls an electronic device, physical access being controlled by a physical barrier system having a physical barrier of which movement is restricted by a lock, the method comprising:
wirelessly receiving, at an access control headend, from the electronic device, digitally signed data that pertain to physical access rights, the electronic device having been configured to transmit the digitally signed data only after the individual has self-authenticated to the electronic device;
determining, in a first computing process, on the basis of the received data, whether the individual is permitted to access the restricted area;
receiving proximity data from the electronic device indicating close physical proximity of the electronic device to the lock;
after (i) determining the individual to be so permitted and (ii) receiving the proximity data, causing the lock to change from the locked state to the unlocked state.

17. A method according to claim 16, wherein the electronic device comprises a smartphone or a tablet computer.

18. A method according to claim 16, wherein wirelessly receiving includes receiving using at least one of Bluetooth, wireless Ethernet, and a cellular telephone network.

19. A method according to claim 16, further comprising storing, in digital storage medium, a database having a collection of records as to the authorization of individuals to access the restricted area.

20. A method according to claim 19, further comprising altering the permission of the individual to access the restricted area by modifying at least one of the records in the database.

21. A method according to claim 16, wherein the electronic device has been configured to transmit the digitally signed data only after the individual has self-authenticated to the electronic device by presenting at least one of a fingerprint of the individual, a handprint of the individual, an iris scan of the individual, a retina scan of the individual, a password, an authorization code, or a personal identification number.

22. A method according to claim 16, wherein the access control gateway is incorporated into the barrier system and receives the digitally signed data from the electronic device when the electronic device is in close proximity to the barrier, so that the digitally signed data additionally serve as the proximity data and the proximity data receiver is configured to receive the digitally signed data.

23. A method according to claim 16, further comprising: after (i) determining the individual to be so permitted and (ii) receiving the proximity data, transmitting a signal to the lock controller, the signal commanding the lock controller to change the state of the lock.

24. A method according to claim 23, wherein the proximity data include at least one of barcode data and RFID data that uniquely identify the lock.

25. A method according to claim 16, further comprising:
generating an authorization code when the received digitally signed data indicate that the individual is authorized to have access to the restricted area;
wirelessly transmitting the authorization code to the electronic device; and
transmitting the authorization code to the lock controller,
wherein the lock controller changes the state of the lock only after receiving the authorization code from the electronic device.

26. A method according to claim 25, wherein the authorization code expires at a given time, the method further comprising granting physical access only until the given time.

27. A method according to claim 25, wherein the authorization code is a randomly generated number.

28. A method according to claim 25, wherein wirelessly transmitting includes transmitting an encrypted message containing the authorization code.

29. A method according to claim 25, wherein the access control gateway is an access control headend, and the proximity data receiver is proximate to the physical barrier system, and the proximity data comprise the authorization code.

30. A method according to claim 16, further comprising:
querying a certificate authority accessible over a network to determine whether a certificate used to digitally sign the digitally signed data has been revoked;
receiving a response to the query from the certificate authority; and
if the response indicates that the certificate has been revoked, then determining that the individual is not permitted to access the restricted area.
